(19) United States
(12) Patent Application Publication
(10) Pub. No.: US 2015/0012301 A1
(43) Pub. Date: Jan. 8, 2015

(54) CONFIGURABLE PLATFORM FOR PATIENT-CENTRIC ACTIONABLE HEALTH DATA

(71) Applicant: Healarium Inc, Wilmington, DE (US)

(72) Inventors: Arturo Weschler, Kfar Saba (IL); Amir Weinstein, Petah Tikva (IL); Eyal Herman, Hod Hasharon (IL); Amnon Keynan, Tel Aviv (IL)

(21) Appl. No.: 14/373,365

(22) PCT Filed: Jan. 31, 2013
(86) PCT No.: PCT/IL2013/050085

§ 371 Date: Jul. 21, 2014

Related U.S. Application Data
(60) Provisional application No. 61/593,339, filed on Feb. 1, 2012.

(51) Int. Cl. G06F 19/00

(52) U.S. Cl. CPC G06F 19/322
USPC 705/3

(57) ABSTRACT

The invention provides a computer system and method for managing a user's health. The invention provides a user with a health plan comprising executable actionable tasks. The health plan is selected for the user according to predefined criteria. Users are given incentives for execution of the tasks of the health plan. The software of the invention receives medical data pertaining to a user, analyzes the medical data and displays the analysis of the medical data in a highly visual display. In one embodiment, medical data is displayed on a color-coded gauge indicating desirability of the medical data, and brief textual messages are provided in layman's terms to indicate any necessary follow-up. The invention may be provided as a website, or as a software application for use on a user's personal electronic device.

### FIELD OF THE INVENTION

The invention relates to computerized aids for tracking one's health. More particularly, the invention relates to software which can be used by clinicians to tailor personal health goals for specific conditions or risk factors, and which individuals can use to easily visualize their progress at attaining those goals. The software displays onscreen specific time-dependent health-related tasks to accomplish, and with incentives based on performance of these tasks. Support groups may be contacted through the website.

### BACKGROUND

Prior art websites for tracking health issues focus on a single medical goal, such as tracking one's progress on a diet plan, and cannot be readily changed or added to without a complete overhaul of the website by a web designer. It would be desirable to provide a single website and application for tracking personal health goals, which may be used to address a plurality of diverse risk groups and which allows social group interaction between users.

Additionally, while a user may initially track their adherence to a health program, their interest and motivation typically drop off soon afterwards, since the user does not usually have sufficient progress or tangible rewards within the first few weeks. It would be desirable to provide a user with a computerized website which he/she can access and use to receive tangible redeemable incentives which encourage a user to adhere to their health plan.

Most individuals are not sufficiently proficient with medical terminology, and do not readily understand the implications of medical test results (biometric data) initiated by their physician/clinician. While they may undergo, for instance, blood tests meant to check their general health or risk for heart disease, they may wait several weeks or months before following up with the physician to determine whether the results indicate they need to change their dietary lifestyle. It would be desirable to provide individuals with a highly visual indication of the desirability of their medical test results, including words of warning or succinct comments to indicate whether follow up is critical.

It is the object of the present invention to overcome the shortcomings of prior art websites. These and other advantages will be described in the detailed description of the invention that follows.

### BRIEF DESCRIPTION OF THE DRAWINGS

For a better understanding of the invention, with regard to the embodiments described, reference is made to the accompanying drawings, in which:

FIG. 1A illustrates a login page of the website of the invention.

FIG. 1B illustrates the homepage of the website of the invention.

FIG. 2A is a screenshot showing gifts that have been configured into the system that will be redeemable for incentive points given for adherence to the plan.

FIG. 2B is a screenshot showing non-tangible incentives that earn a user a higher rank in task-completion.

FIG. 3 is a screenshot showing a user's medical data upon a red/green color-coded gauge indicating desirability of the results.

FIGS. 4-6 are screenshots showing comprehensive descriptions of a user's medical data, including analysis and textual; instructions for future.

FIG. 7 illustrates addition of new medical data.

FIG. 8-9 illustrates a user's specifically tailored health plans.

FIG. 10 describes in detail how to adhere to a user's health plan.

FIG. 11 shows a user earning incentive points for viewing an instructional health-related video.

FIG. 12-13 show a user reporting his adherence to his health plan.

FIGS. 14-15A illustrate social networking with additional registered users.

FIG. 15B illustrates a weeklong task to encourage exercise.

FIG. 15C describes personal coaches to encourage adherence with the health plan.

FIG. 15D illustrates popular healthy recipes and easy exercises.

FIGS. 16-17 illustrate screenshots viewable by administrators monitoring the website of the invention.

FIG. 18 illustrates the invention has the form of a software application for a mobile phone.

It will be appreciated that for simplicity and clarity of illustration, elements shown in the drawings have not necessarily been drawn accurately or to scale. Reference numerals may be repeated among the drawings to indicate corresponding or analogous elements. Moreover, some of the blocks depicted in the drawings may be combined into a single function.

### SUMMARY OF THE INVENTION

The present invention aids in tracking, managing and improving one's health, by providing an electronically accessible plan of recommendations, targets and actionable tasks, which improve an individual's health and manage chronic conditions he/she may experience. The invention engages a user and motivates the user to become interested in his/her own health. The invention may be provided to organizations such as health plans, HMO's or care delivery organizations, for distribution to their patients, and is configurable to reflect the organization's particular medical expertise. Alternatively, the invention may be provided to individual users.

A user is encouraged to open their individualized actionable health data and to accomplish their health goals by earning points that may translate to redeemable incentives, such as gift cards for purchases, or monetary discounts for medical care. In some instances, the points earned are used to rate the user's health management success, and thus are merely motivational and not redeemable for physical rewards.

The invention is unique in its design, which allows clinicians and their supporting staff to readily build plans suited for a wide variety of medical domains and health conditions which require management and monitoring.

While prior art websites for tracking health issues focus on a single medical goal, such as weight loss, the software of the present invention allows a medical expert to readily prepare a module containing recommendations, goals and tasks for any additional medical condition or medical domain he wishes to address, and to upload them easily onto the website of the invention. Non-limiting examples of medical conditions which require tracking include: wellness promotion, pregnancy monitoring, diabetes or pre-diabetes management, follow-up for patients with congestive heart failure, diet and exercise tracking, and smoking cessation. The software of the invention allows a medical domain expert to build a generic actionable plan for users, to transform recommendations automatically into personal daily actionable tasks, and to track a user's adherence to the plan. The software allows a medical domain expert to enter his/her recommendations into the software's configuration tools, which are automatically prepared for display to a user on the website of the invention. The invention may have the form of a network-based Internet website and optionally a mobile phone application, which a user may access periodically using any electronic device, including a handheld mobile-phone, a tablet, a laptop or a personnel computer. Alternatively, the invention may be provided to a user as software for use in a personal computer or another electronic device having a processor and a display. The user's remote electronic device (personal computer, PDA, mobile phone or laptop) may be equipped with any computer-associated peripherals known in the art, such as a mouse, a display screen, a keyboard, etc.

The invention thus provides a computer system for managing a user's health, the system comprising a server configured to communicate with a plurality of users; the server comprising:
i. computer associated peripherals;
ii. a processor interacting with the peripherals, the processor including a memory device, a driver; display means; the processor being in communication with the memory device, and being configured to:
   identify a recognized user or register a new user;
   provide a user with a health plan comprising executable tasks, the health plan selected for the user according to predefined medical criteria;
   provide a user with incentives for execution of the tasks of the health plan;
   receive medical data pertaining to a user;
   analyze the medical data;
   display the analysis of the medical data in a highly visual display, and provide the user with the display.

The invention additionally provides an electronic method of managing a person's health, using an electronic device, the method comprising the following steps:
identifying a recognized user or registering a new user;
providing the user with a health plan comprising executable tasks, the health plan selected for the user according to predefined medical criteria;
providing the user with incentives for execution of the tasks of the health plan;
receiving medical data pertaining to the user;
analyzing the medical data;
providing a user with a highly visual display of the analysis of the medical data, for display upon the user's electronic device.

Additionally provided is computer-readable storage medium storing an executable software application adapted to perform the method of the invention.

For the sake of clarity the following terms are defined explicitly:

The term “computer-readable storage medium” refers to any type of medium to which data may be saved and later retrieved for handling, using a computer. Examples include, but are not limited to, a hard drive, floppy disk, CD, DVD, or flash memory.

The term “electronic device” useful for carrying out the invention, refers to an electronic apparatus having processing means, and display means, which may be used to carry out the invention. Preferably, the device includes communication means as well. Non-limiting examples include: a personal computer, a PDA, a mobile phone, a tablet, and a laptop computer.

The term “medical domain expert” refers to medical personnel familiar with a particular disease, health condition or risk group. Medical domain experts are capable of planning a series of executable health-related tasks which would benefit patients included in the risk group. The medical domain expert can similarly define the interpretation rules governing limits for acceptable medical test results (biometric data), so that the software of the invention will display proper interpretation of any user's medical test results. Non-limiting examples of medical domain experts include physicians, medical technicians, bioinformatics experts, etc.

The terms “actionable tasks” and “executable tasks” are intended to convey health-related tasks which a user is encouraged to execute. These tasks may directly improve a user's health. Alternatively, these tasks may educate a user on a specific health condition or may provide general health recommendations (wellness recommendations), or may be used to gather data from the user. Non-limiting examples of such tasks include: measuring and reporting weight, walking for 20 minutes, eating 10 almonds, or watching a short video on diabetes prevention.

The term “calendar-specific tasks” refers to tasks which a user is advised to perform within an upcoming time frame. Typically, they are assigned to a user to perform within the next several weeks, and are given concrete dates for performance, merely to encourage a user to execute the tasks. There is no particular relevance to the dates assigned rather linkage to a specific time-frame translates abstract health recommendations into concrete executable steps which users tend to perform.

The term “medical data” in relation to the method and system of the invention refers to measured, reported or derived personal data. These include for instance, medical test results, physical activity reports, physical attributes, or adherence to a health plan as reported by a user.

The terms “biometric data” and “medical data” are used interchangeably; “biometric data” refers to personal physical attributes, and does not necessarily refer to use of these attributes in identification of an individual for security purposes.

### DETAILED DESCRIPTION OF THE INVENTION

In the following detailed description, numerous specific details are set forth in order to provide a thorough understanding of the present invention. There is no intention to limit the invention to the details of construction and the arrangement of the components set forth in the following description or illustrated in the drawings. The invention is capable of other embodiments or of being practiced or carried out in various ways. Also, it is to be understood that the phraseology and terminology employed herein are for the purpose of description and should not be regarded as limiting.

In general, the present invention provides interactive software useful for tracking a user's health. Medical test results are automatically interpreted, displayed in a highly visual manner such as a “red/green color-coded gauge” and placed in an informative context which a layman can readily understand. The acceptability of the test results is evaluated, and a banner-type summary is displayed so a patient can understand how to proceed.

The software additionally provides a user with health-specific actionable tasks which are linked to upcoming due dates, so that a user has concrete instructions how to maintain his health. Such “actionable” tasks have a high rate of user compliance, as they are highly specific, tangible, and assigned for particular due dates.

Performance of a health-related task earns the user incentive points, which may be redeemable for tangible prizes. Alternatively, the points earned are merely “onscreen” points.

The software of the invention may be easily configured to suit a plurality of health issues which require tracking, and thus is therefore suitable for various health-related organizations, such as clinics and HMO's. Private users may benefit from the invention as well.

This is in contrast to prior art websites, which typically address only a single health related issue, such as tracking exercise or diet, and need to be totally redesigned to add reference to other health issues.

In certain embodiments the invention is a predefined website, utilizing a dedicated server running the software of the invention, and users may communicate with the server via their personal electronic devices (personal computers, cellular phones, tablets, PDAs, etc.). Alternatively, the software may be provided to individual users, for instance in the form of a mobile-phone application.

In the following detailed description the invention is described in relation to functions and experiments typical for tracking one's general health profile. This is for illustrative purposes only, and the invention may be utilized with medical data originating in any field of interest. The scope of the invention is not limited to use in tracking only general health, rather includes for instance, pregnancy monitoring, diabetes or pre-diabetes management, follow-up for patients with congestive heart failure, Chron's Disease, wellness promotion, diet and exercise tracking, smoking cessation and numerous other fields.

Additionally, while in the following description the invention is described as a website accessible by a user, this is just one form the software may have. Other forms include a software application for a mobile-phone or for another electronic device such as a personal computer, etc.

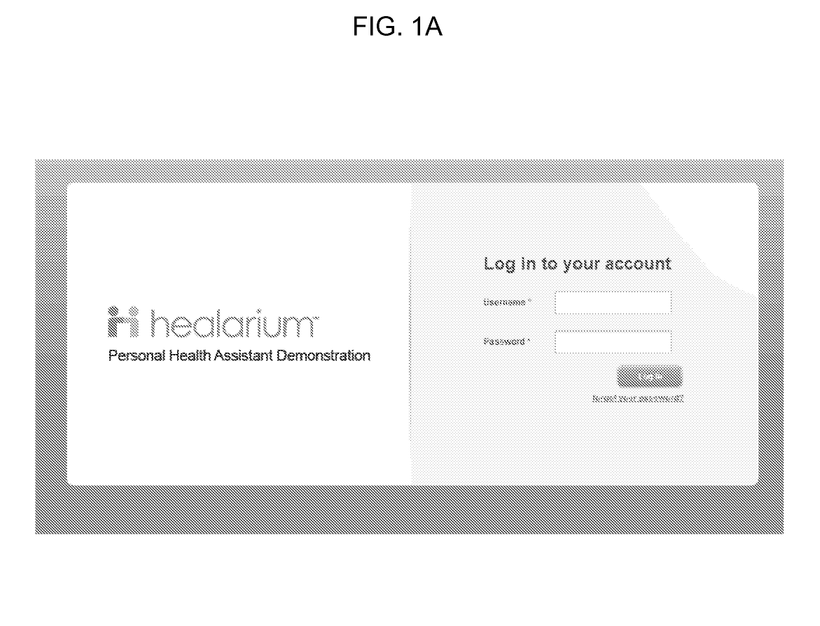

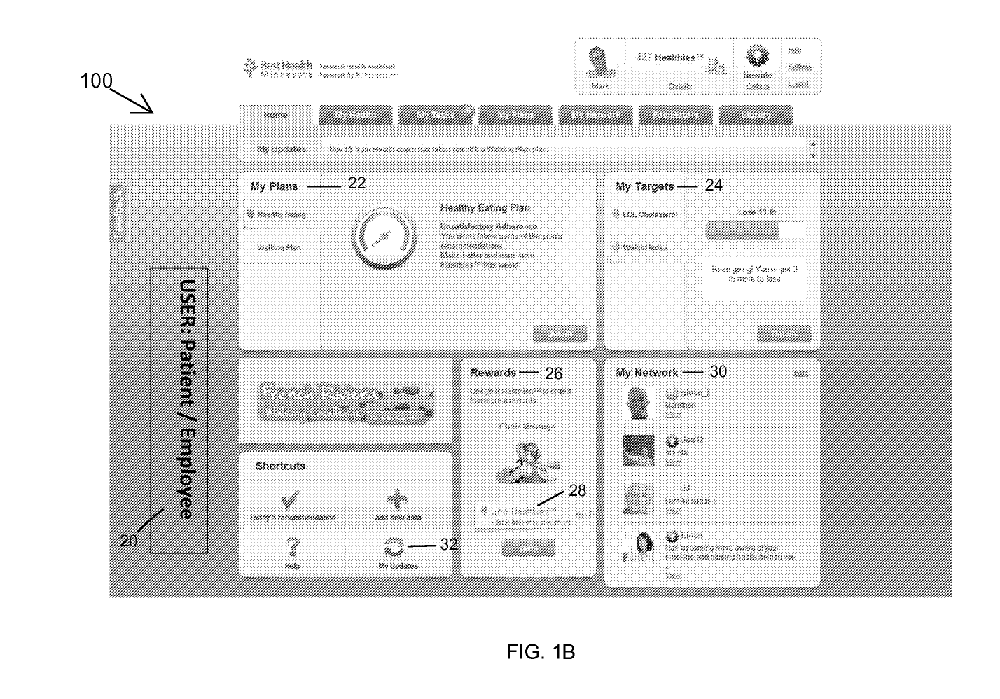

Referring now to FIG. 1A, the login page of the website of the invention is illustrated. A user enters his username and password to access his own medical data. Alternatively, the user may be routed from any other web page such as an enterprise portal utilizing single-sign-on capabilities, while skipping the login page.

Referring now to FIG. 1B, the homepage 100 of the website of the invention is illustrated. The clinician has assigned a pre-configured personal plan which a patient may access by pressing the “my Plans” button 22. The personal plan is tailored to automatically suit the targets of the specific patient, such as losing for instance, 20 pounds, or lowering his cholesterol to a predefined number. These targets are viewable in the “My Targets” panel 24 at right.

A user may view the Rewards panel 26 to see which gifts are available as incentives, and may see the number of incentive points he has amassed towards this, termed “Healthies” 28.

A social network is accessible through the My Network panel 30, where a user can contact others sharing similar health conditions to receive support and encouragement.

The My Update panel 32 displays brief updates to the user, such as brief information on his progress and may ask whether he is ready to move to the next step of his plan, which may be maintaining his current health achievements.

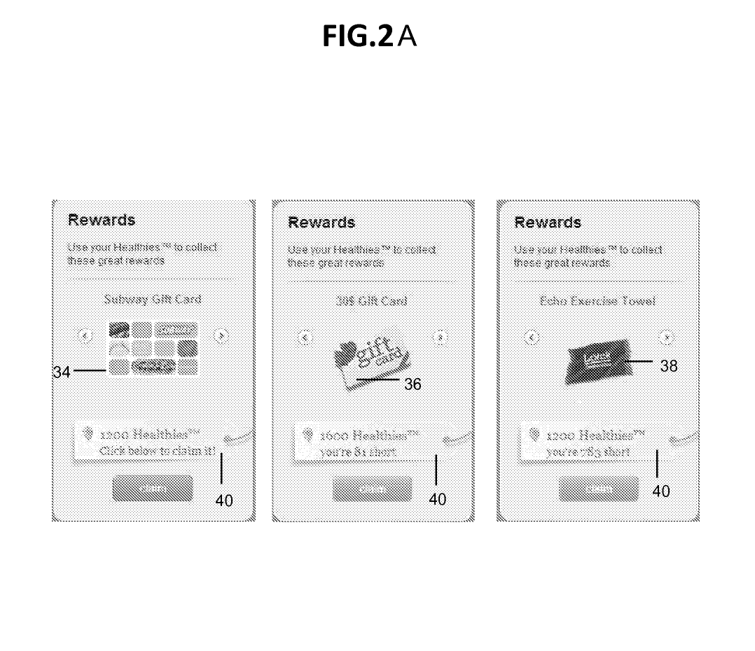

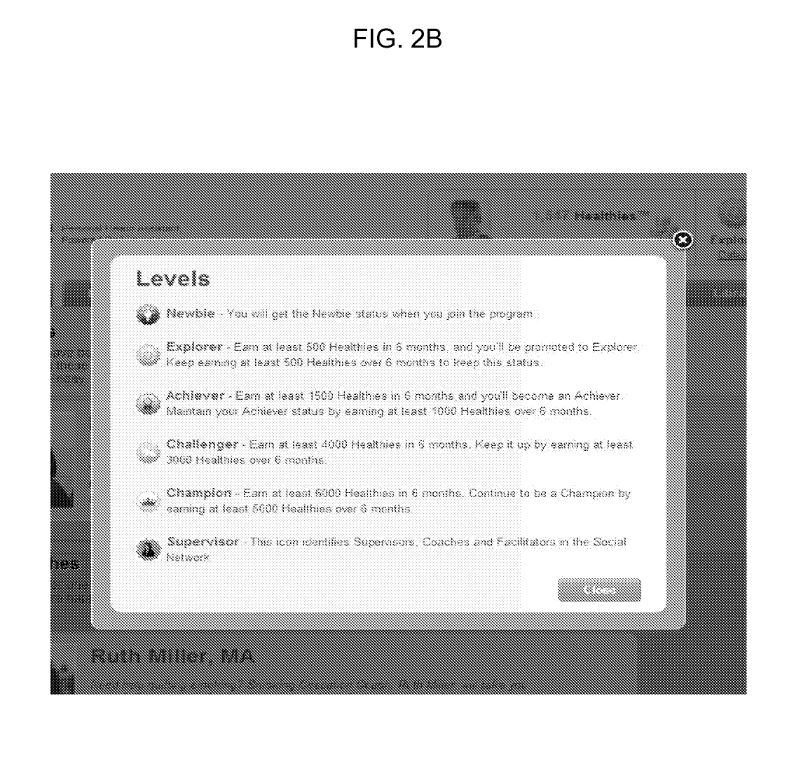

Referring to FIG. 2A, the user has clicked on the Rewards panel 26 to view the gifts that have been configured into the system and are available for him when he collects the appropriate number of “Healthies™” (incentive points given for different events such as completing tasks, showing adherence to the plan and for improvement of measured health data). Examples of rewards shown are a gift card to Subway™ 34, a 30$ gift card to a flower store 36, and an exercise towel 38. Beneath each reward is shown the number of Healthies™ remaining 40 till the user is eligible to earn the gift.

Referring to FIG. 2B, in an alternative configuration, Healthies™ earn a user a higher rank. The level achieved by a user (e.g. “Newbie/Explorer/Champion”) is displayed adjacent to his screen name, and is shown during social interactions among registered users. Thus, the incentive in this embodiment is a motivational encouragement in the form of a status symbol, and not redeemable towards physical prizes.

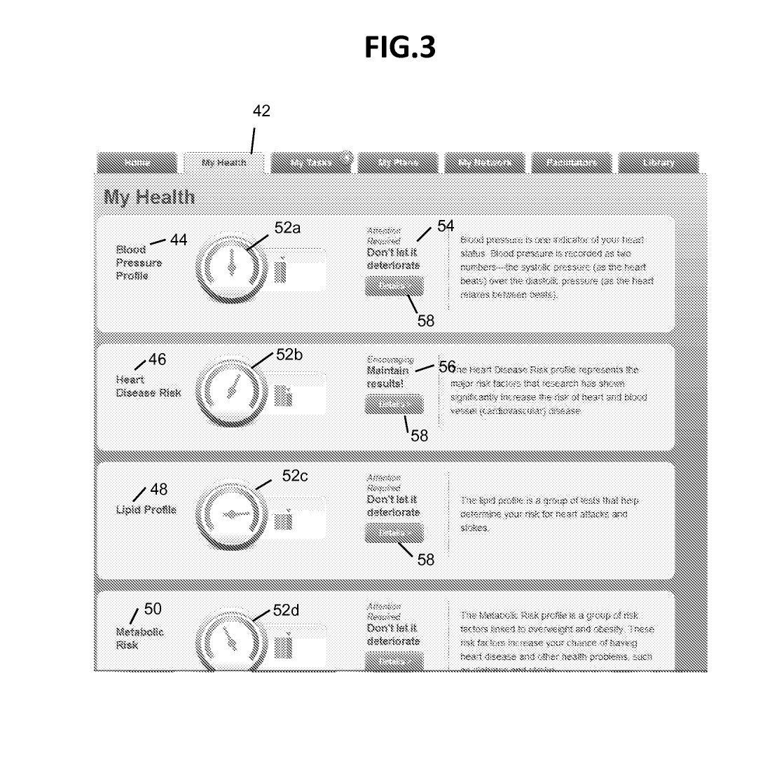

Referring to FIG. 3, a user has selected the My Health tab 42, to view his measured, reported or derived biometric data. This may include general health profiles as defined by the medical domain expert, for example: Blood pressure profile 44, heart disease risk 46, lipid profile 48, and metabolic risk 50. The profiles are displayed in a highly visual manner, such as the red/green color-coded gauges shown 52a-52d, which illustrate whether the user's risks are in the acceptable range (typically displayed in green) or in the danger zone (typically displayed in red). The acceptable or unacceptable ranges for medical test results are preconfigured by a medical domain expert. A written description of the desirability of the profile value and its trend is provided adjacently to the gauge, such as “don't let it deteriorate” 54, or “thumbs up” 56. A user may click on the “more details” tabs 58, to receive more description on the desirability of each measurement, and what can be done.

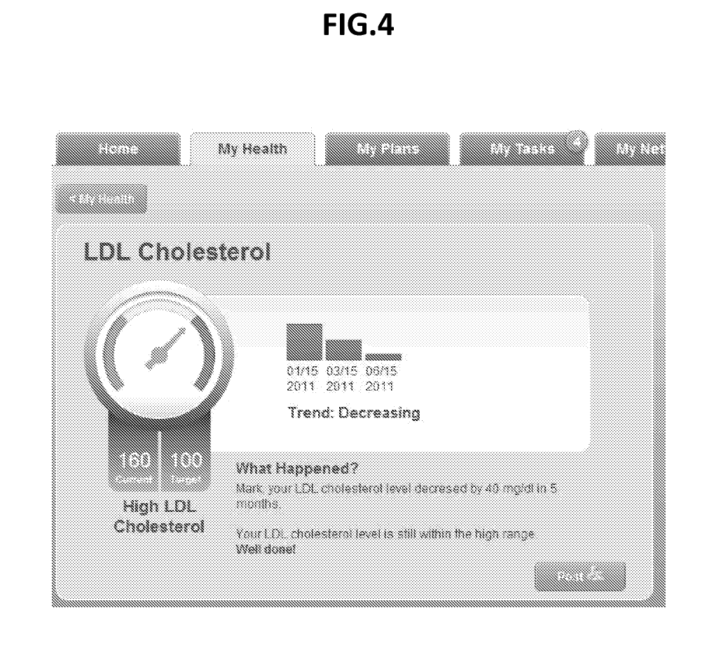

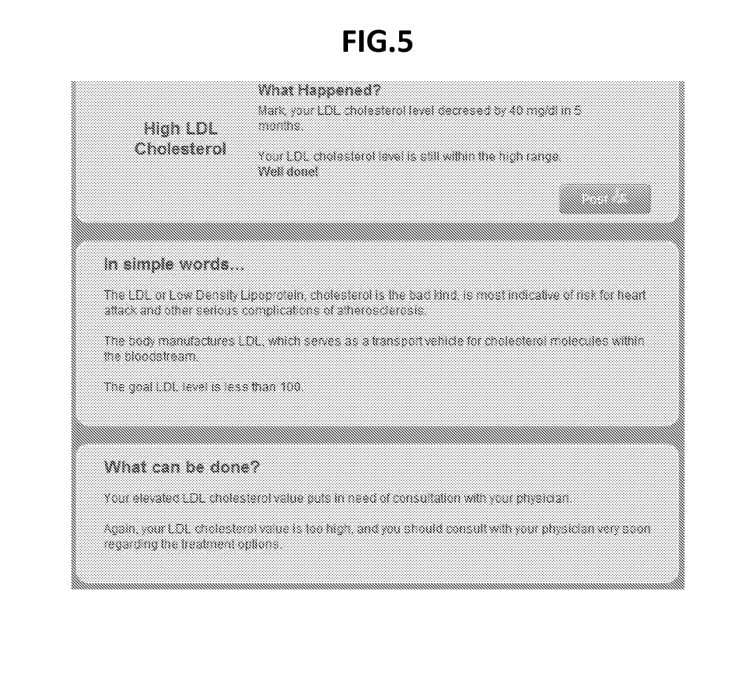

Referring to FIG. 4, and FIG. 5, the user has clicked on the “more details” tabs, to receive a comprehensive description of the specific measurements that affect the selected profile, such as his progress concerning his LDL cholesterol measurements, how this affects his health and what action steps he can take to improve his test results.

Referring, for instance, to FIG. 4, a bar graph is shown plotting several previous measurements, to show the trend, and in FIG. 5 the blurbs “What Happened”, “In Simple Words” and “What Can be Done” explain the implications of the medical test results to the layman. The contents of these screens are preconfigured by a medical domain expert most familiar with the specific medical condition associated with the test results being viewed.

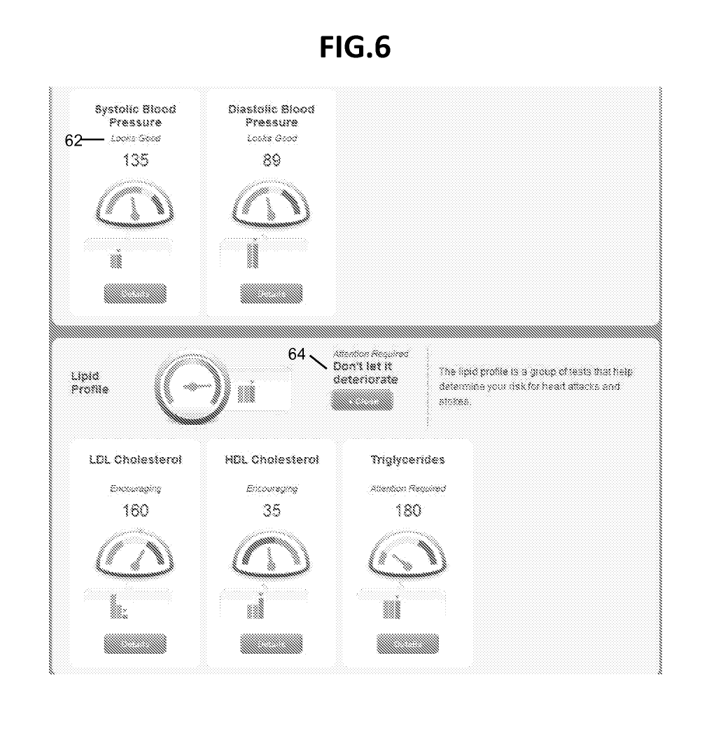

Referring to FIG. 6, additional medical data is visually displayed within red/green color-coded gauges which clearly inform the user if his results are desirable or need improvement. A “desirability” label is additionally given to each measurement, such as “looks good” 62 for the Systolic Blood Pressure, and “attention required” and “don't let it deteriorate” 64 for the lipid profile.

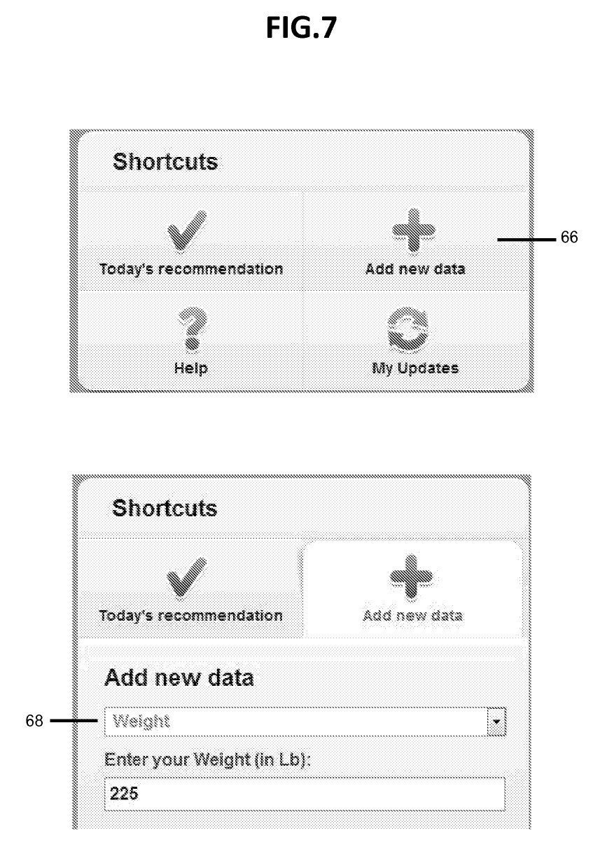

Referring to FIG. 7, a user may add new medical data, by clicking on the “add new data” 66 button on the Shortcut screen shown. The tab will then open, as shown in the lower half of FIG. 7, and the user may select from the pull-down menu which data he is entering; in this case, his weight 68 is being updated to be 225 (lbs).

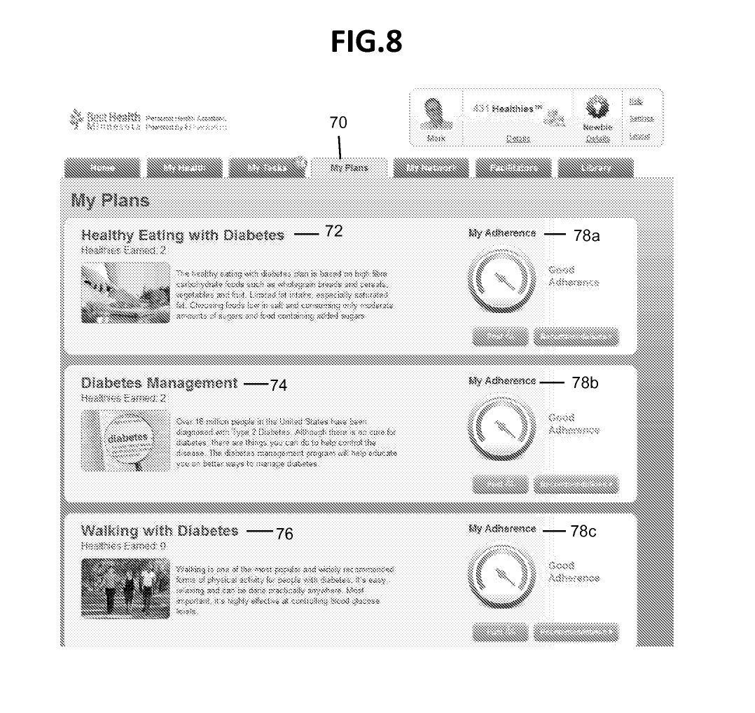

Referring now to FIG. 8, the My Plans tab 70 has been pressed, to display the user's specifically tailored plans. In this instance, the user has three plans: Healthy Eating with Diabetes 72, Diabetes Management 74, and Walking with Diabetes 76. The user's self-reported adherence to each plan is shown on a red/green color-coded gauge at right 78a, 78b, 78c.

The user has been provided with these specifically tailored plans automatically. Alternatively, a clinician acting in an administrative capacity may review medical data and self declared targets of all new users and may then tailor a health plan accordingly.

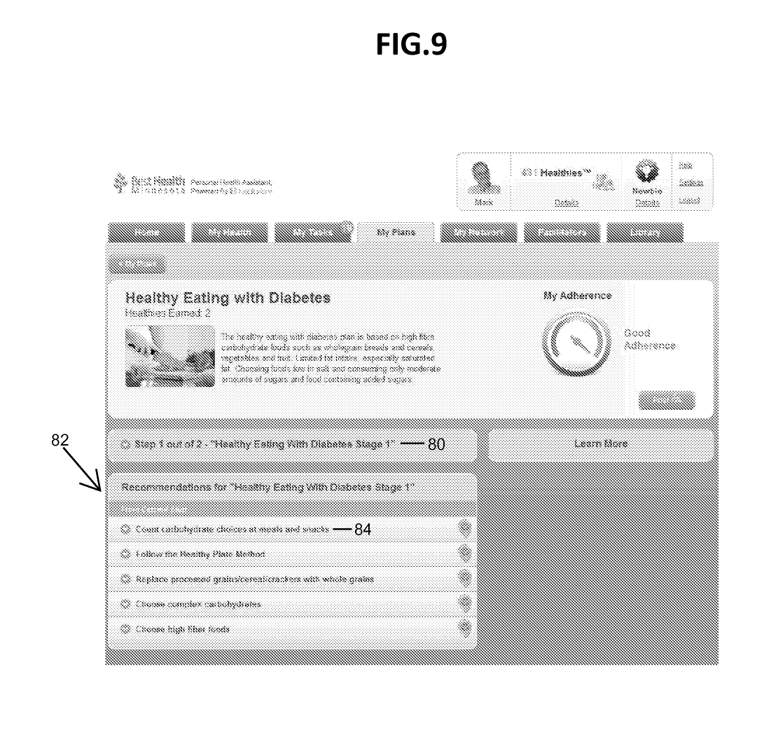

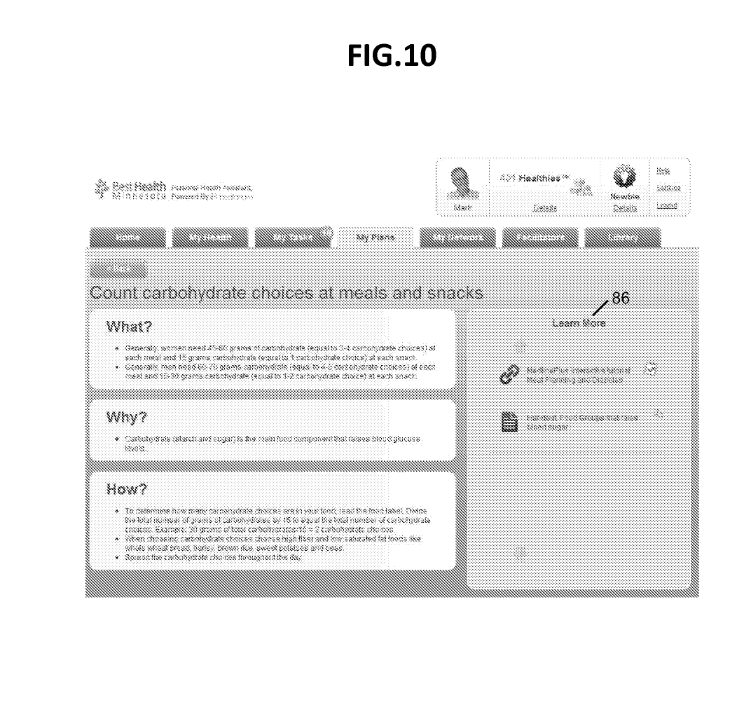

Referring to FIG. 9, the user has clicked on the tab “Healthy Eating with Diabetes 72”, to open this plan. The user is at a beginner stage of the plan, termed “Stage 1” 80, and detailed Recommendations 82 are visible at the lower part of the screen, on how to follow the plan. Clicking on any of the specific recommendations will open up a more detailed description, such as shown in FIG. 10 after a user has clicked on “count carbohydrate choices as meals and snacks” 84.

Referring to FIG. 10, the “what, how and why” is displayed, describing the proper way and reasoning to count carbohydrate choices.

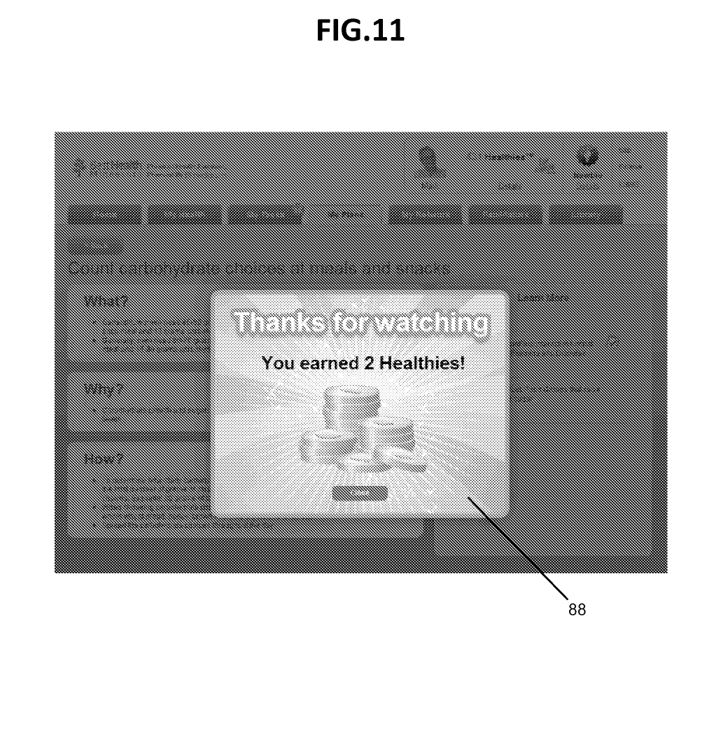

The user may select the “Learn More” panel 86 to view additional material such as a short instructive video on the subject, and he will be credited with “Healthies” bonus points, as shown in FIG. 11.

Referring to FIG. 11, the user is rewarded for viewing the instructive video related to accomplishing his plan, and is informed by a pop-up 88 that he has earned 2 “Healthies” points.

The invention is unique in providing a user with daily and weekly actionable tasks, which break up his health plans into easily actionable small actions, thus encouraging engagement, involvement and adherence. Each task has a deadline, and is rated in terms of the “Healthies” bonus points it will earn. While prior art websites for tracking health give general advice (e.g. “avoid extra calories”), the invention gives concrete “bite-sized” tasks, such as “eat five almonds today”, “use the stairs today”, or “eat a daily breakfast at home”, which are to be performed in a specific timeframe. This encourages adherence, and a user becomes more actively involved with his health regimen. The tasks are both doable and highly descriptive.

An additional advantage of the invention is its construction allows rapid addition of content to address additional medical domains and conditions. The software queries a medical domain expert and allows him to quickly define allowable ranges for new medical tests, and to easily enter banner-type ratings that will be displayed for a user when his medical results are automatically interpreted by the software. The medical professional can readily define what recommendations will be displayed, and the system is easily configurable to suit a particular clinic's patient needs. New medical test results are displayed in a highly visual manner, such as upon “red/green color-coded gauges” shown in relation to FIG. 3.

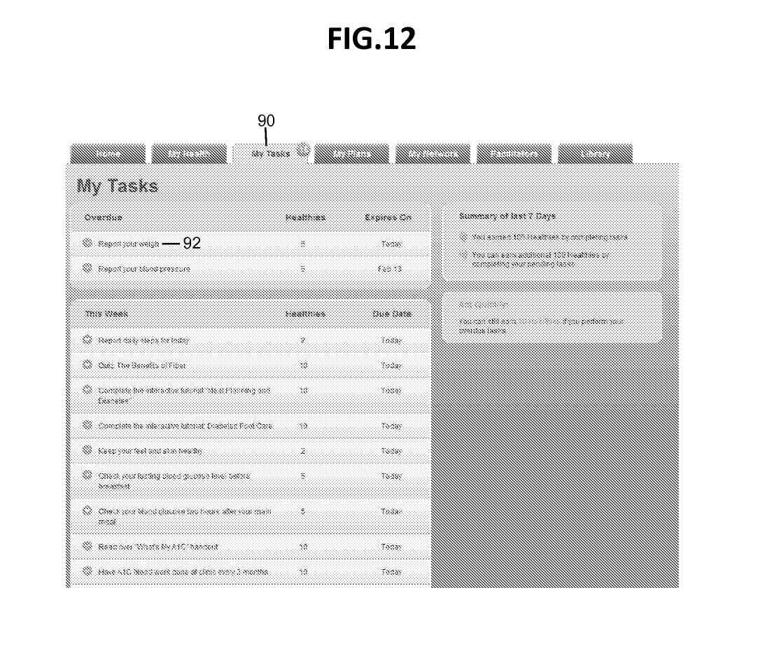

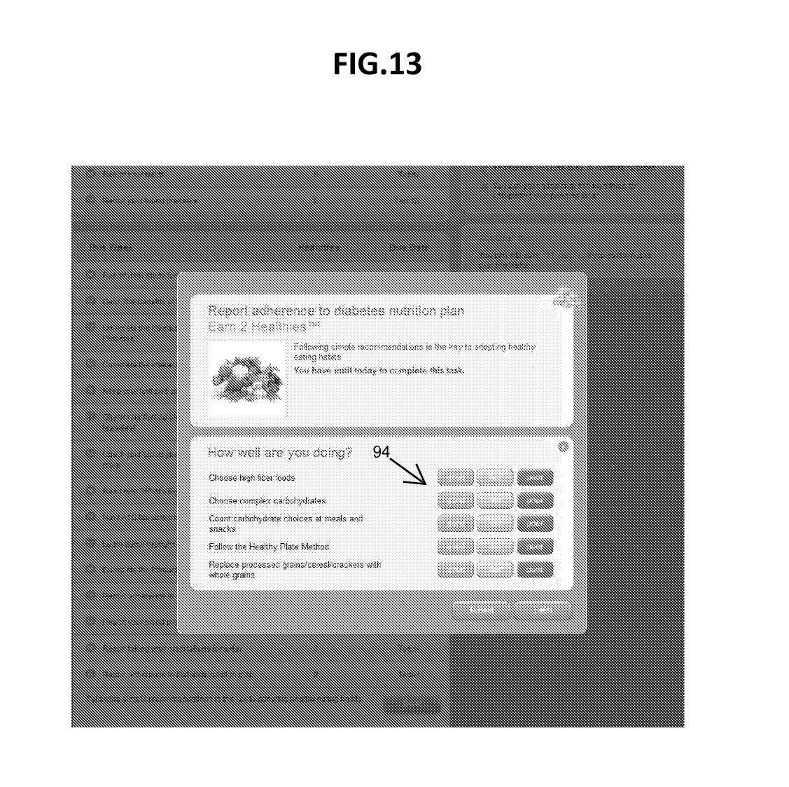

Referring to FIG. 12, the “My Tasks” tab 90 has been selected. One task is “Reporting the adherence to the Healthy Nutrition Plan” 92. The user may click on this task to open the report shown in FIG. 13.

Referring to FIG. 13, the user may report his adherence to his health recommendations, by clicking on one of the ratings “good/fair/poor” 94 for each task line.

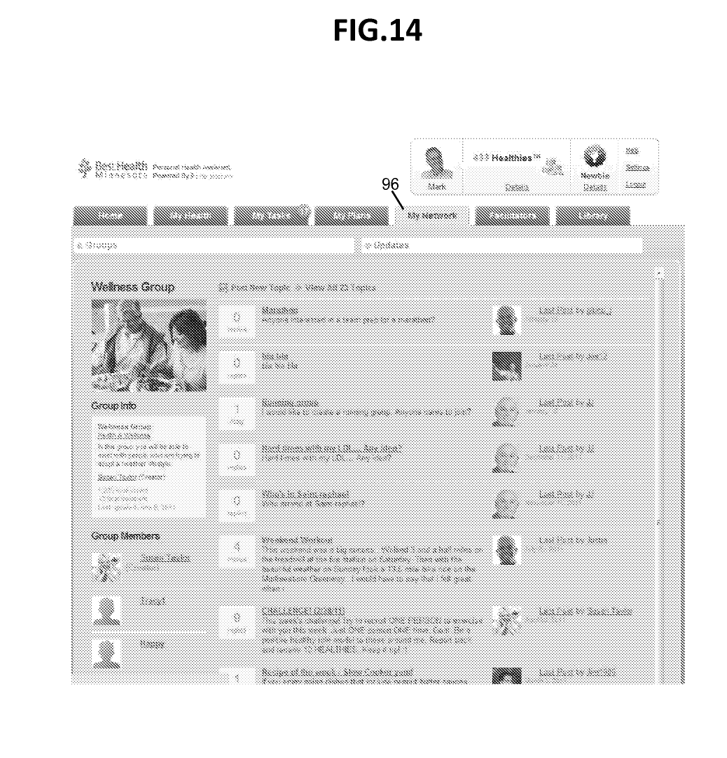

Referring to FIG. 14, the user has clicked on the My Network tab 96, in order to reach the social network page showing recent posts from other members, including from members of any social groups he has joined.

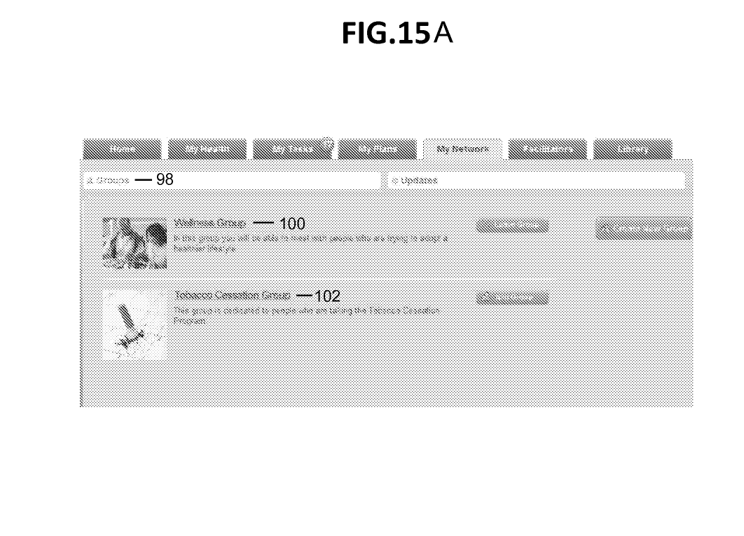

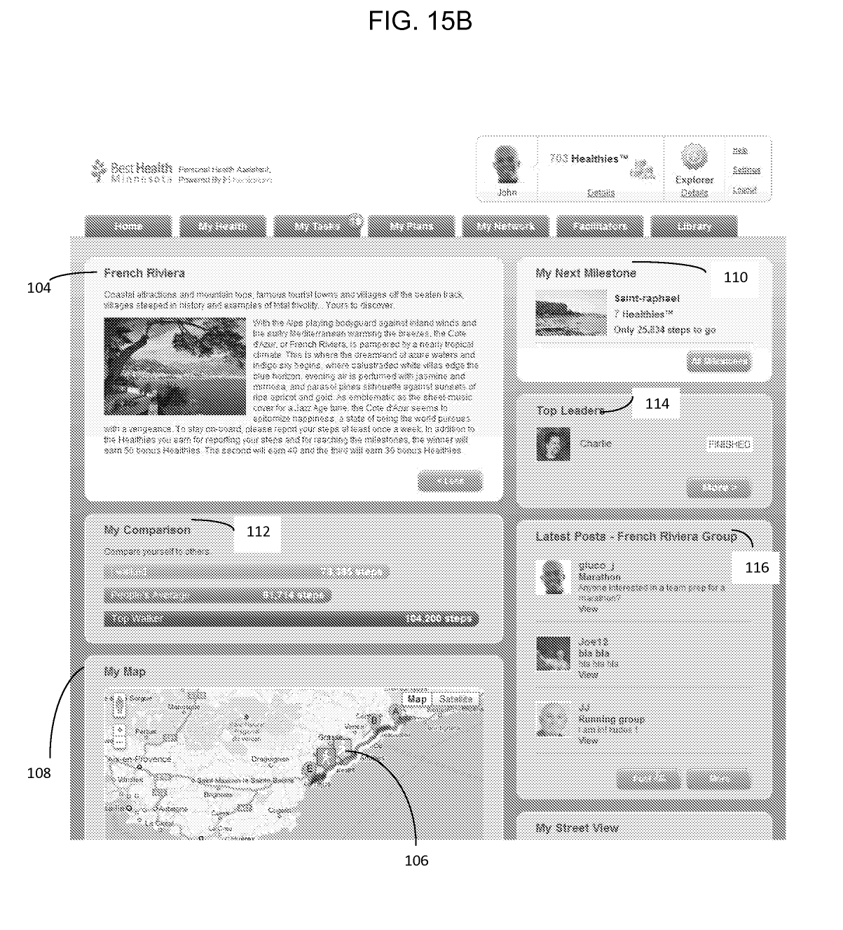

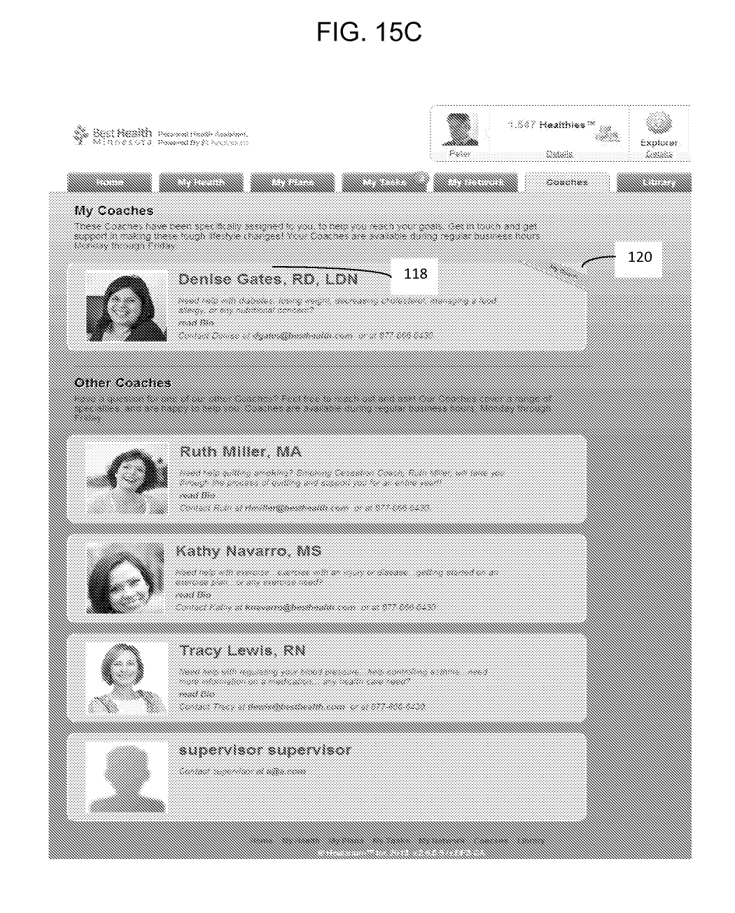

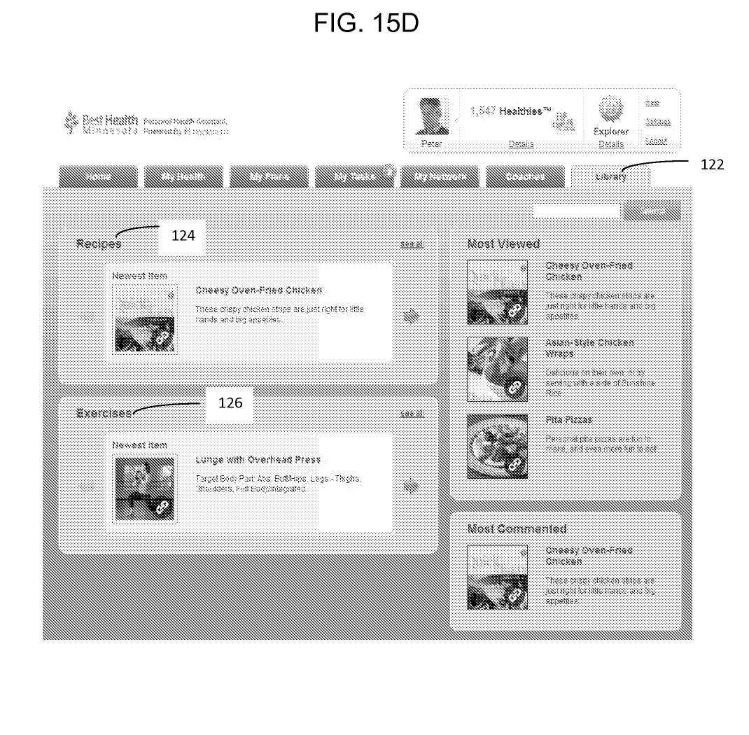

Referring to FIG. 15A the user has clicked on the Groups button 98, to view which groups have been set up and are currently active. The user may choose to join either the Wellness Group 100, or the Tobacco Cessation Group 102. Social networks provide members with emotional support which aids in successful adherence to a health plan, and may also provide members with answers to specific health situations they have also encountered.

Referring now to FIG. 15B, a configurable “challenge” has been set up by the administrator to encourage users to exercise. Users report the distance they have walked in their hometown each day, and this is plotted on a simulated course around an interesting far removed venue (for example, “French Riviera” 104). They will be informed which milestones they have reached thus far (“My Next Milestone” 110), with simulated progress 106 shown on a map (“My Map” 108). Their progress is compared to that of other real users (“My comparison” 112). Thus, while a user does not have to leave his own city, his imaginative travel adds interest to his walk, and encourages adherence to the exercise program. Users may see who the “Top Leaders” 114 are, or may view “Latest Posts” 116 of other registered users participating in this challenge.

Referring to FIG. 15C, personal coaches may be assigned to each user, with coaches having skills appropriate to the user's health goals. Thus, for instance, Denise Gates 118 is described as someone a user can contact via the website of the invention to receive help with diabetes or weight loss. A banner “My Coach” 120 appears at the right-hand corner of the Denise Gates panel, to indicate this coach has been assigned to this user.

Referring to FIG. 15D, the “Library” Tab 122 has been selected, to display additional informative or educational material set up by the administrator. For example, healthy recipes 124 and easy exercises 126.

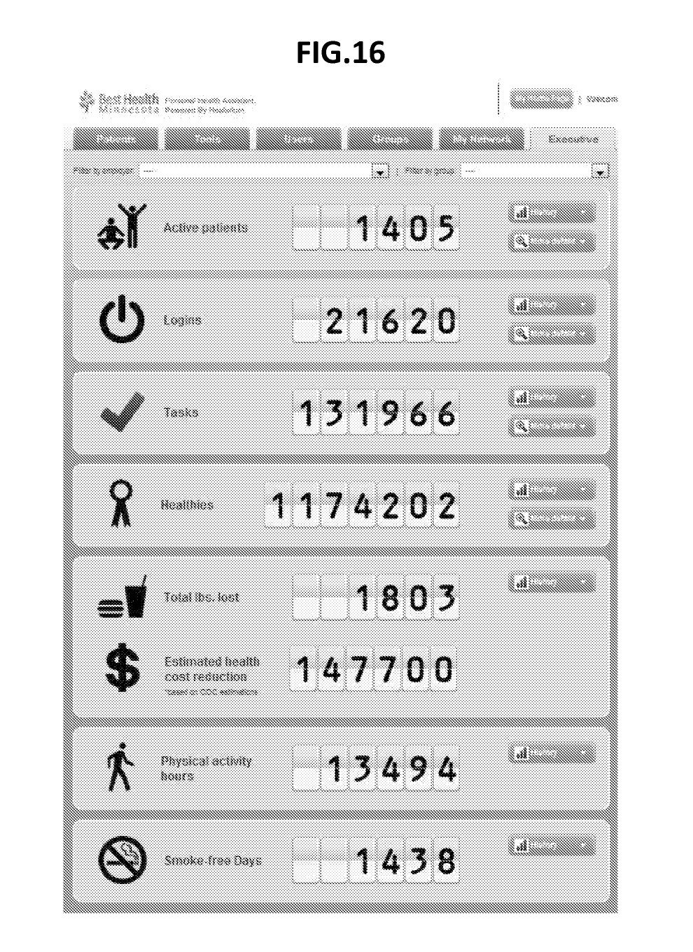

Referring to FIG. 16, executives monitoring the website of the invention may receive visual information such as the number of users, the number of logins per time period, etc. this data provides an overview of the success rate of the health plans and of the website of the invention. The website personnel may choose to alter the screens shown to tailor them accordingly.

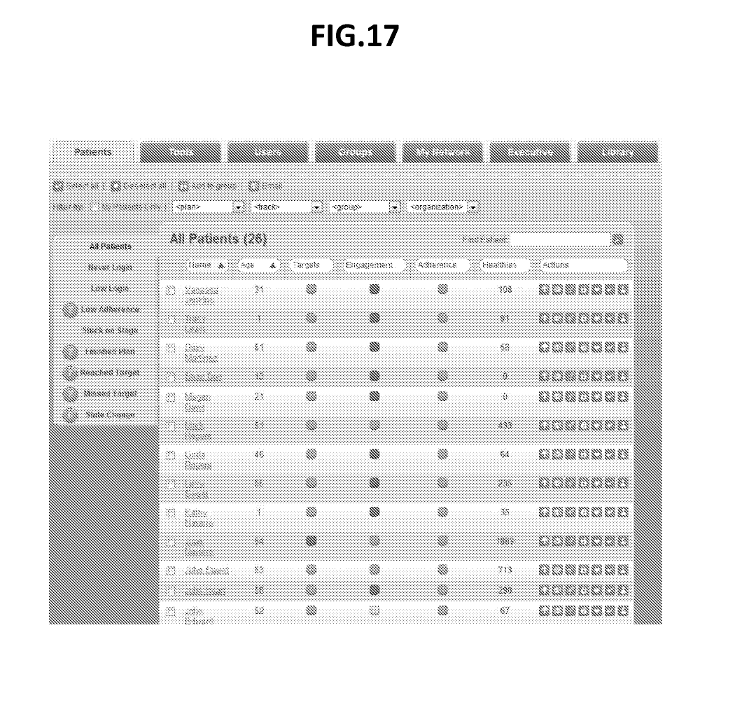

Referring to FIG. 17, the supervisor or clinician may view information related to specifically identified patients, to determine who requires attention by checking their adherence to their plans, whether they are accessing the website consistently, and how many Healthies™ they have earned. Information is shown in a color-coded manner (e.g.—a green square in the table represents a high rating, while a red square represents a poor rating).

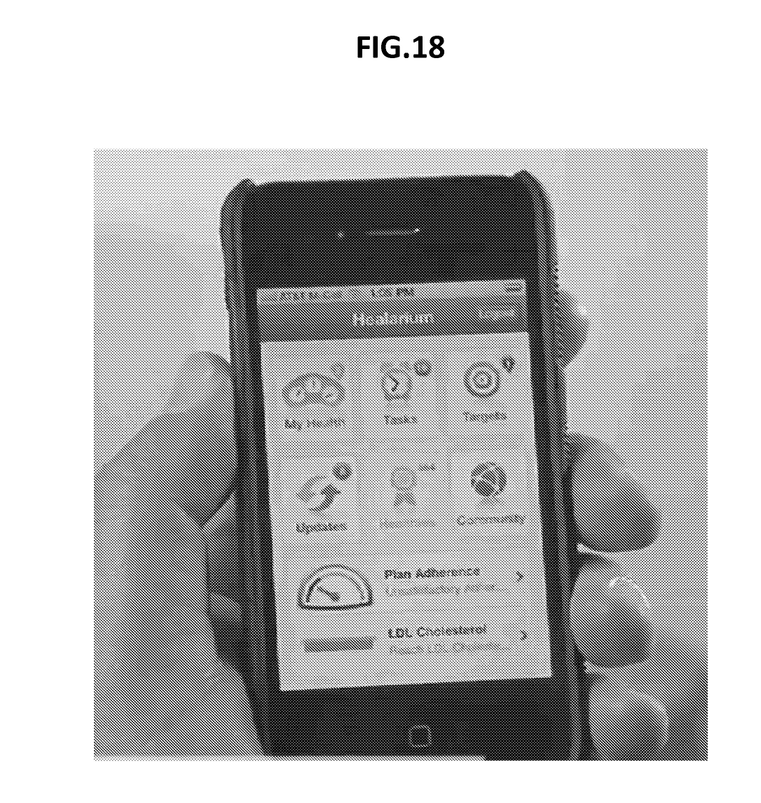

Referring to FIG. 18 the invention may be accessed via a user's smart-phone, thus allowing the user to access his plan and update his data conveniently at any time from any location.

In summary, the invention provides a software platform which is readily configurable to address a plurality of medical conditions, and which can display numerous biometric data (medical test results) in a highly visual and easily understandable manner, such as in a “red/green color-coded gauge”. Layman's terms are shown along with banner-type headlines to allow users to readily understand the implications of their medical test results.

Additionally, small health-related actionable tasks are scheduled for each user. Redeemable incentives or intangible incentives such as performance grading and social networking among users encourage adherence to a health regimen.

The invention is embodied in any suitable programming language or combination of programming languages, including Python, Django, HTML, Google Web Toolkit, JAVA, database managers and MySQL.

Each software component can be implemented in a high-level procedural or object-oriented programming language, or in assembly or machine language if desired. The programming language may be a compiled or interpreted language.

The software of the invention is operable from any suitable computer, computer system or related group of computer systems known in the art. In one embodiment, the software is installed upon a server or server computer system which is connected by at least one input/output port to a communication network. The communication network may be a local area network connecting a plurality of computers via any suitable networking protocol, including but not limited to Ethernet. In another embodiment, the communication network is the Internet and the system comprises server software capable of communicating with client computers via the Internet via any suitable protocol, including but not limited to HTTPS. In such case, the invention may be provided to a user as software as a service (SaaS) which will obviate a user from hardware needs such as a server and necessary server maintenance, security, etc. In one embodiment, a user may use a browser such as Internet Explorer™, Mozilla Firefox, Chrome or Safari, to browse on the server via the internet. Any processing device may be utilized, including for instance, a personal computer, a laptop, a PDA or a cellular phone.

Suitable processors for implementation of the invention include, by way of example, both general and special purpose microprocessors. Generally, a processor will receive instructions and data from a read-only memory and/or a random access memory.

Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EPROM, and flash memory devices; magnetic disks such as internal hard disks and removable disks; magneto-optical disks; and CD-ROM disks.

Medical test results are entered into and saved in a database which may be any suitable database for storing data objects and metadata relating thereto. Any suitable database program may be used. In one embodiment, the database is a relational database and a key/value database. In one embodiment, database is a modified relational database. The search logic used for subsequent retrieval of experiments from the database, is any suitable step, process, function or series of steps, processes and functions known in the art for searching a database.

The software of the invention typically includes a graphical user interface (GUI). The contents of the screens, the functionality of the system and the work process may be adjustable to a user's needs. The screen designs, terms and work process are user-friendly since they display and interact with the user in a highly visual manner. Thus use of the system may appear intuitive.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the invention or exceeding the scope of the appended claims.

1. A computer system for managing a user's health, said system comprising a server configured to communicate with a plurality of users; said server comprising:
i. computer associated peripherals;
ii. a processor interacting with said peripherals, said processor including a memory device, a driver; display means; said processor being in communication with said memory device, and being configured to:
a) identify a recognized user or register a new user;
b) provide a user with a health plan comprising executable tasks, said health plan selected for said user according to predefined medical criteria;
c) provide a user with incentives for execution of said tasks of said health plan;
d) receive medical data pertaining to a user;
e) analyze said medical data;
f) display said analysis of said medical data in a highly visual display, and provide said user with said display.

2. The computer system of claim 1, wherein said server is configured to allow an administrator to address new medical conditions by:
querying an administrator for definitions of allowable ranges for a new medical condition; querying an administrator for recommendations to display to a user based upon analysis of medical data; and displaying medical data on a new medical condition in a highly visual display.

3. The computer system of claim 1, wherein said executable tasks in said step b) are time-dependent health tasks.

4. The computer system of claim 1, wherein said executable tasks in said step b) are selected from: exercise tasks, diet tasks, reviewing educational material on health issues, accessing a user's health plan, and contacting a registered user or an administrator.

5. The computer system of claim 1, wherein said highly visual display is a color-coded gauge.

6. The computer system of claim 1, wherein said incentives in said step c) are selected from: redeemable physical prizes, and motivational encouragement.

7. The computer system of claim 1, wherein said processor is further configured to monitor a user's adherence to said health plan, and provide a user with feedback related to said user's adherence to said health plan.

8. The computer system of claim 1, wherein said processor is further configured to aid a user with contacting additional registered users via electronic social networking.

9. The computer system of claim 1, wherein said plurality of users may communicate with said server using an electronic device selected from: a personal computer, a cellular phone, a tablet and a personal digital assistant (PDA).

10. The computer system of claim 1, wherein said medical data is selected from one or more of the following: medical test results, a physical activity report, physical attributes reported by a user, and reported adherence to a health plan.

11. The computer system of claim 1, wherein said health plan includes executable tasks suited for tracking one or more of the following: general health, pregnancy monitoring, diabetes or pre-diabetes management, follow-up for users with congestive heart failure, Crohn's Disease, diet tracking, exercise tracking, and smoking cessation.

12. The computer system of claim 1, wherein said step b) of providing said user with a health plan is performed automatically after analysis of a user's medical data in step e) based upon predefined medical criteria.

13. The computer system of claim 1, wherein a user is provided with brief textual messages related to said medical data, for indicating desirability of said medical data and for suggesting action necessary.

14. An electronic method of managing a person's health, using an electronic device, said method comprising the following steps:
a) identifying a recognized user or registering a new user;
b) providing said user with a health plan comprising executable tasks, said health plan selected for said user according to predefined medical criteria;
c) providing said user with incentives for execution of said tasks of said health plan;
d) receiving medical data pertaining to said user;
e) analyzing said medical data;
f) providing a user with a highly visual display of said analysis of said medical data, for display upon said user's electronic device.

15. The method of claim 14, wherein said executable tasks in said step b) are time-dependent health tasks.

16. The method of claim 14, wherein said executable tasks in said step b) are selected from: exercise tasks, diet tasks, reviewing educational material on health issues, accessing a user's health plan, and contacting a registered user or an administrator.

17. The method of claim 14, wherein said highly visual display is a color-coded gauge.

18. The method of claim 14, wherein said incentives in said step c) are selected from: redeemable physical prizes, and motivational encouragement.

19. The method of claim 14, further comprising monitoring a user's adherence to said health plan, and providing a user with feedback related to said user's adherence to said health plan.

20. The method of claim 14, further comprising aiding a user with contacting additional registered users via electronic social networking.

21. The method of claim 14, wherein said electronic device is selected from: a personal computer, a cellular phone, a tablet and a personal digital assistant (PDA).

22. The method of claim 14, wherein said medical data is selected from one or more of the following: medical test results, a physical activity report, physical attributes reported by a user, and reported adherence to a health plan.

23. The method of claim 14, wherein said health plan includes executable tasks suited for tracking one or more of the following: general health, pregnancy monitoring, diabetes or pre-diabetes management, follow-up for users with congestive heart failure, Crohn's Disease, diet tracking, exercise tracking, and smoking cessation.

24. The method of claim 14, wherein said step b) of providing said user with a health plan is performed automatically after analysis of a user's medical data in step e) based upon predefined medical criteria.

25. The method of claim 14, wherein said method has the form of a website, or a software application for use on a personal electronic device.

26. The method of claim 14, wherein a user is provided with brief textual messages related to said medical data, for indicating desirability of said medical data and for suggesting action necessary.

27. Computer-readable storage medium storing an executable software application adapted to:
a) provide a user with a health plan comprising executable tasks, said health plan selected for said user according to predefined medical criteria;
b) provide said user with incentives for execution of said tasks of said health plan;
c) receive medical data pertaining to said user;
d) analyze said medical data;
e) provide a user with a highly visual display of said analysis of said medical data, for display upon said user's electronic device.
